(19) United States
(12) Patent Application Publication
(10) Pub. No.: US 2007/0086802 A1
(43) Pub. Date: Apr. 19, 2007

(54) Method and apparatus for applying developing bias voltage in image forming apparatus

(75) Inventors: Joong-gwang Shin, Seongnam-si (KR); Jin-cheol Kim, Suwon-si (KR); Yoo-seok Yang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/490,034

(22) Filed: Jul. 21, 2006

(30) Foreign Application Priority Data
Oct. 18, 2005 (KR) 2005-0098226

(51) Int. Cl. G03G 15/06

(52) U.S. Cl. 399/55

(57) ABSTRACT

A method and apparatus for applying a developing bias voltage of an image forming apparatus are provided. When an image is formed on paper, an AC bias voltage and a DC bias voltage are applied in an overlapping manner to the developing roller, and when an image is not formed on paper, the AC bias voltage is turned off and only the DC bias voltage is applied to the developing roller.

### CROSS-REFERENCE TO RELATED PATENT APPLICATIONS

This application claims the benefit under 35 U.S.C. § 119(a) of Korean Patent Application No. 10-2005-0098226, filed on Oct. 18, 2005, in the Korean Intellectual Property Office, the entire disclosure of which is hereby incorporated by reference.

### BACKGROUND OF THE INVENTION

1. Field of the Invention

The present invention relates to a method and apparatus for applying a developing bias voltage in a non-contact image forming apparatus. More particularly, the present invention relates to a method and apparatus for applying a developing bias voltage in a non-contact type image forming apparatus, by which method toner is prevented from moving from a developing roller to a photosensitive medium during a time when a sheet of paper is spaced apart from another sheet of paper by a predetermined gap during a printing operation.

2. Description of the Related Art

In general, image forming apparatuses using electrophotography are devices which form an electrostatic latent image on a photosensitive medium using an exposure unit such as a laser scanning unit, in response to a digital image signal, develop the electrostatic latent image using a developing agent, transfer the developed image onto a recording medium and fuse the transferred image on the recording medium by heat and pressure, thereby forming an image.

Image forming apparatuses can be classified into dry type image forming apparatuses and wet-type image forming apparatuses according to the state of developing agent. Dry type image forming apparatuses can be classified into image forming apparatuses having a one-component developing unit and image forming apparatuses having a two-component developing unit.

The one-component developing unit forms an image by supplying only toner. The two-component developing unit forms an image by supplying carrier to which toner particles are attached, using toner and carrier.

A plurality of developing cartridges in which toner of colors such as cyan (C), yellow (Y), magenta (M), and black (K) is stored overlap one another, and one color is superimposed onto another, thereby forming a color image.

Image forming apparatuses include a photosensitive medium on which an electrostatic latent image is formed, and a developing roller which develops the electrostatic latent image by supplying a developing agent. Image forming apparatuses can be classified into contact type image forming apparatuses and a non-contact type image forming apparatuses depending on whether the photosensitive medium and the developing roller are spaced apart from each other by a predetermined gap.

In contact type image forming apparatuses, the photosensitive medium and the developing roller are attached to each other, a DC bias voltage is applied to the developing roller, and toner is moved from the developing roller to the photosensitive medium using a potential difference between the photosensitive medium and the developing roller.

In non-contact type image forming apparatuses, the photosensitive medium and the developing roller are spaced apart from each other by a predetermined gap, a DC bias voltage and an AC bias voltage are applied in an overlapping manner to the developing roller, and toner jumps from the developing roller to the photosensitive medium.

However, a developing voltage is applied to the developing roller in all time periods where a printing operation is performed using a conventional non-contact type image forming apparatus, even in a time period between printing media, or in a time period where an image is not formed on the photosensitive medium, such as a time period where warming-up is performed before printing or cleaning is performed after printing. As a result, toner may be easily scattered by a potential difference between the developing roller and the photosensitive medium, which may cause image and apparatus contamination.

Accordingly, there is a need for an improved method and apparatus for preventing the scattering of toner in an image forming apparatus.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for applying a developing bias voltage in a non-contact type image forming apparatus by which an AC bias voltage applied to the developing roller is turned off in a time period where an image is not formed, thereby preventing scattering of toner.

According to another aspect of exemplary embodiments of the present invention, there is provided a method and apparatus for applying a developing bias voltage in an image forming apparatus, in which a predetermined bias voltage is applied to a developing roller to generate a potential difference between the developing roller and a photosensitive medium. When an image is formed on paper, both an AC bias voltage and a DC bias voltage are applied in an overlapping manner to the developing roller, and when an image is not formed on paper, the AC bias voltage is turned off and the DC bias voltage is applied to the developing roller.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic side cross-sectional view of an electrophotolithographic image forming apparatus according to an exemplary embodiment the present invention;

FIG. 2 is a side view of a bias voltage applied to a developing roller, supply roller, and transfer roller illustrated in FIG. 1; and

FIG. 3 is a timing diagram for explaining time when a developing bias voltage is applied to the developing roller.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope of the invention. Also, descriptions of well-known functions and constructions are omitted for clarity and conciseness.

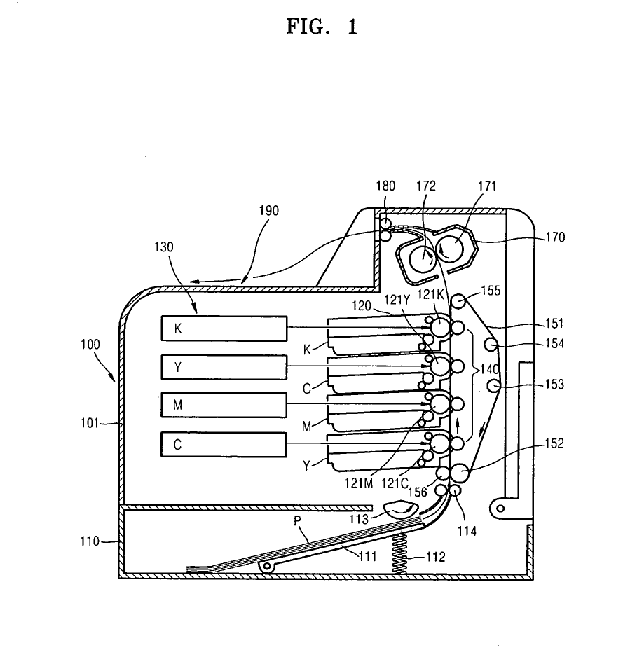

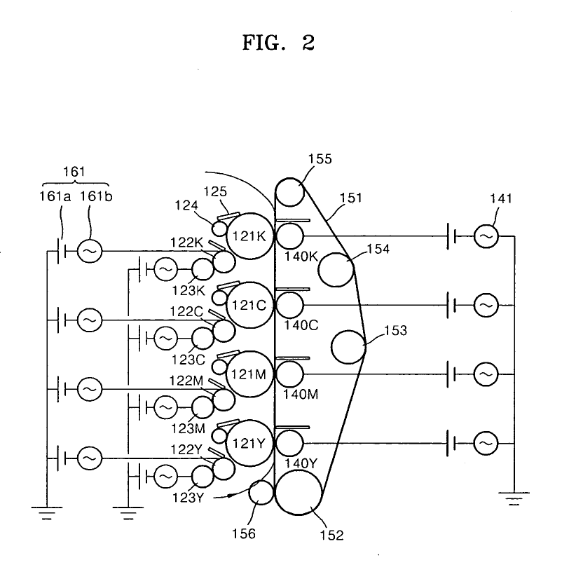

Referring to FIGS. 1 and 2, an electrophotolithographic image forming apparatus 100 prints an image on paper using an electrophotolithographic process. The electrophotolithographic image forming apparatus 100 includes a cassette 110 on which paper P is stacked and which can be attached and detached to and from a main body 101.

The cassette 110 is elastically biased in an upward direction by a spring 112 and includes a paper support 111 on which the paper P is stacked. A pickup roller 113 is installed above the cassette 110 which picks up the paper P one by one while rotating.

The electrophotolithographic image forming apparatus 100 includes a plurality of developing cartridges 120, a plurality of exposure units 130, a transfer roller 140, a carrier belt 151, a fusing unit 170, and a paper discharging unit 180.

The developing cartridges 120 store toner, supply the toner to an electrostatic latent image corresponding to a printing digital signal, and develop the electrostatic latent image as a toner image. The developing cartridges 120 include a plurality of developing cartridges 120C, 120M, 120Y and 120K in which toner of colors such as cyan (C), magenta (M), yellow (Y) and black (K) is stored.

Each of the developing cartridges 120 includes a photosensitive drum 121 on which an electrostatic latent image corresponding to an image to be printed is formed using the exposure units 130, a developing roller 122, which is spaced apart from the photosensitive drum 121 by a predetermined gap and moves and attaches the toner to the electrostatic latent image formed on the photosensitive drum 121 using a potential difference between the developing roller 122 and the photosensitive drum 121, and a supply roller 123, which supplies the toner to the developing roller 122.

A charging roller 124 and a cleaning blade 125 make contact with the photosensitive drum 121. The charging roller 124 charges the photosensitive drum 120 to a predetermined potential, and the cleaning blade 125 removes waste toner remaining on the surface of the photosensitive drum 121 after the developed image is transferred onto the paper P.

The exposure units 130 form an electrostatic latent image corresponding to a printing digital signal by radiating light onto the photosensitive drums 121C, 121M, 121Y and 121K. The exposure units 130 include a plurality of exposure units 130C, 130M, 130Y and 130K corresponding to the developing cartridges 120C, 120M, 120Y and 120K, respectively. If necessary, an electrostatic latent image can also be formed by radiating light onto each of the photosensitive drums 121C, 121M, 121Y and 121K using one exposure unit.

The carrier belt 151 is supported by a plurality of rollers 152, 153, 154 and 155, rotated on a looped curve, allows the paper P picked up from the cassette 110 and conveyed by a conveying roller 114 to face the developing cartridges 120C, 120M, 120Y and 120K one after the other. At this time, the carrier belt 151 consecutively contacts the photosensitive drums 121C, 121M, 121Y and 121K and is rotated.

A charging roller 156 is installed below the carrier belt 151. The charging roller 156 contacts the carrier belt 151 and charges the carrier belt 151 to a predetermined potential. The charging roller 156 charges the carrier belt 151 to a predetermined potential so that the paper P can be attached to the carrier belt 151.

A plurality of transfer rollers 140 is installed to face the developing cartridges 120C, 120M, 120Y and 120K, respectively. At this time, the carrier belt 151 is placed between the transfer roller 140 and the developing cartridge 120. Images formed on the photosensitive drums 121C, 121M, 121Y and 121K, respectively, are transferred onto the paper P conveyed by the conveying belt 151.

The fusing unit 170 fuses the developed image on the paper P. The fusing unit 170 includes a heating roller 171 which heats the developed image, and a pressing roller 172 which presses the paper P facing the heating roller 171 and passing between the fusing unit 170 and the heating roller 171 toward the heating roller 171.

The paper discharging unit 180 discharges the paper P on which the developed image is fused when passing the fusing unit 170, to the outside. The paper discharging unit 180 is installed so that a pair of rollers face each other, and discharges the paper P on which the developed image is fused, to the outside. The paper P is discharged by the paper discharging unit 180 and stacked on a paper discharging board 190 disposed above the image forming apparatus.

Referring to FIG. 2, the developing rollers 122K, 122C, 122M and 122Y are connected to a developing bias voltage 161 including a DC bias voltage 161a in series combination with an AC bias voltage 161b. Thus, because of a bias voltage applied in an overlapping or additive manner from the DC bias voltage 161a and the AC bias voltage 162a, the developing rollers 122K, 122C, 122M and 122Y, respectively, are charged to a predetermined potential. The photosensitive drums 121C, 121M, 121Y and 121K are also charged by the charging roller 124 to a predetermined potential and an exposed portion by the exposure units 130 has a different potential from an unexposed portion, due to a potential difference between the developing rollers 122K, 122C, 122M and 122Y and the photosensitive drums 121C, 121M, 121Y and 121K. As a result, the toner is caused to jump and move from the developing rollers 122K, 122C, 122M, and 122Y to the photosensitive drums 121C, 121M, 121Y and 121K and to attach to the electrostatic latent image.

The developing rollers 122K, 122C, 122M and 122Y and the photosensitive drums 121C, 121M, 121Y and 121K are formed in a non-contact type manner in which they are spaced apart from one another by a predetermined gap. Thus, in order to transfer the toner from the developing rollers 122K, 122C, 122M and 122Y to the photosensitive drums 121C, 121M, 121Y and 121K, the DC bias voltage 161a and the AC bias voltage 161b are applied in an overlapping or additive manner to the developing rollers 122K, 122C, 122M and 122Y so that the toner can be caused to jump and move as described above.

The supply rollers 123K, 123C, 123M and 123Y are connected to a supply bias voltage 162. The transfer rollers 140K, 140C, 140M and 140Y are connected to a transfer bias voltage 141.

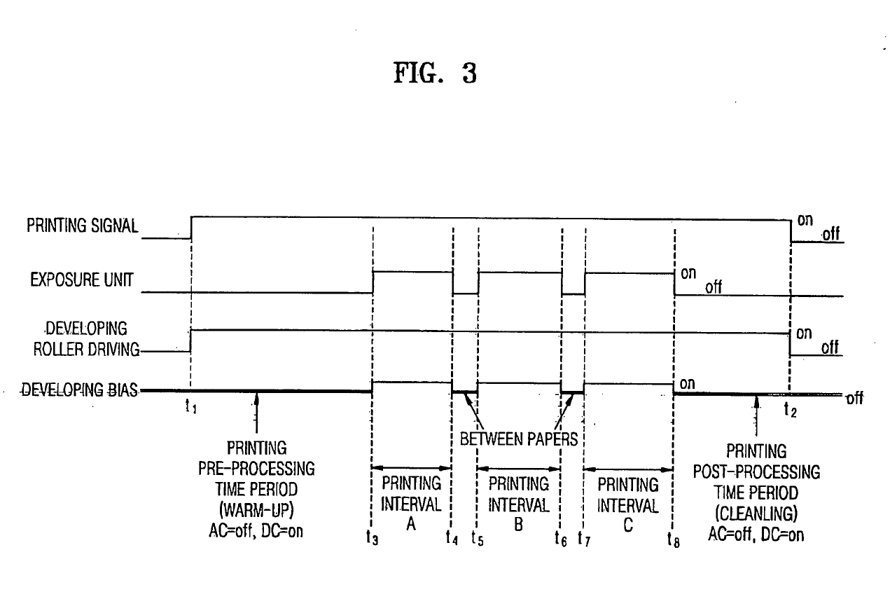

Referring to FIG. 3, if a printing signal for printing an image is transmitted to the image forming apparatus 100 during a time period from t1 to t2, the developing roller 122 is rotated and driven during a time period from t1 to t2.

In printing intervals A, B and C, the exposure units 130 form the electrostatic latent image corresponding to the image on the photosensitive drum 121. In other time periods, for example, in a printing pre-processing time period (warm-up time period) from t1 to t3, in a time period between papers among the intervals A, B and C from t4 to t5 and from t6 to t7, and in a printing post-processing time period (cleaning time period) from t8 to t2, the exposure units 130 are turned off.

In the printing intervals A, B and C, the AC bias voltage 161a and the DC bias voltage 161b of the developing bias voltage 161 are applied to the developing roller 122 so that the toner is attached to the electrostatic latent image. In other time periods, for example, in a printing pre-processing time period (a warm-up time period) from t1 to t3, in a time period between papers P among the intervals A, B and C from t4 to t5 and from t6 to t7, and in a printing post-processing time period (a cleaning time period) from t8 to t2, the AC bias voltage 161b is turned off and the DC bias voltage 161a is applied to the developing roller 122.

In the printing intervals A, B and C in which the paper P is conveyed by the carrier belt 151 and passes the photosensitive drum 121 and an image is formed, both the AC bias voltage 161b and the DC bias voltage 161a are applied to the developing roller 122. The printing intervals A, B and C represent time periods in which an image is formed on the paper P.

On the other hand, in the printing pre-processing time period (the warm-up time period), in the time period between the papers P and in the printing post-processing time period (the cleaning time period), the DC bias voltage 161a is applied to the developing roller 122 and the AC bias voltage 161b is turned off. If only the DC bias voltage 161a is applied to the developing roller 122, the toner is attached to the surface of the developing roller 122 by interaction caused by a potential difference between the photosensitive drum 121 and the developing roller 122.

The AC bias voltage 161b allows the toner to be easily caused to jump from the developing roller 122 to the photosensitive drum 121 and the toner that may be attached to a non-latent image region of the photosensitive drum 121 to be moved to the developing roller 122. Thus, if the AC bias voltage 161b is applied to the developing roller 122, the toner may be easily detached from the surface of the developing roller 122, and may be scattered and contaminate the image forming apparatus 100.

Thus, when an image is not formed, the AC bias voltage 161b is not applied to the developing roller 122 but the DC bias voltage 161a is applied to the developing roller 122 such that the toner is attached to the surface of the developing roller 122 and is prevented from being detached therefrom.

As described above, in the method of applying a developing bias voltage of an image forming apparatus according to exemplary embodiments of the present invention, in non-image time periods, the AC bias voltage is turned off but the DC bias voltage is applied to the developing roller such that the toner is prevented from scattering and contaminating the image forming apparatus.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of applying a developing bias voltage of an image forming apparatus, the method comprising:
applying a bias voltage to a developing roller to generate a potential difference between the developing roller and a photosensitive medium,
wherein, during a time period when an image is formed on paper, an AC bias voltage and a DC bias voltage are applied in an overlapping manner to the developing roller, and during a time period when an image is not formed on paper, the AC bias voltage is turned off and the DC bias voltage is applied to the developing roller.

2. The method of claim 1, wherein the developing roller and the photosensitive medium are arranged in a non-contact type manner in which the developing roller and the photosensitive medium are spaced apart by a gap.

3. The method of claim 2, wherein the time period when an image is not formed on paper comprises a time period in which paper is not conveyed.

4. The method of claim 2, wherein the time period when an image is not formed on paper comprises a warm-up time period before printing.

5. The method of claim 2, wherein the time period when an image is not formed on paper comprises a cleaning time period after printing.

6. The method of claim 1, wherein the time period when an image is not formed on paper comprises a time period in which paper is not conveyed.

7. The method of claim 1, wherein the time period when an image is not formed on paper comprises a warm-up time period before printing.

8. The method of claim 1, wherein the time period when an image is not formed on paper comprises a cleaning time period after printing.

9. An image forming apparatus comprising a developing bias voltage, the apparatus comprising:
a photosensitive drum for forming an electrostatic latent image;
a charging roller for charging the photosensitive drum to a potential;
a developing roller for transferring and attaching toner to the electrostatic latent image; and
a bias voltage comprising a DC bias voltage and an AC bias voltage applied to the developing roller, for charging the developing roller to a potential difference from the photosensitive drum,
wherein, during a time period when an image is formed on paper, the AC bias voltage and DC bias voltage are applied in an overlapping manner to the developing roller, and when an image is not formed on paper, the AC bias voltage is turned off and the DC bias voltage is applied to the developing roller.

10. The apparatus of claim 9, wherein the developing roller and the photosensitive drum are arranged in a non-contact type manner in which the developing roller and the photosensitive drum are spaced apart by a gap.

11. The apparatus of claim 10, wherein the time period when an image is not formed on paper comprises a time period in which paper is not conveyed.

12. The apparatus of claim 10, wherein the time period when an image is not formed on paper comprises a warm-up time period before printing.

13. The apparatus of claim 10, wherein the time period when an image is not formed on paper comprises a cleaning time period after printing.

14. The apparatus of claim 9, wherein the time period when an image is not formed on paper comprises a time period in which paper is not conveyed.

15. The apparatus of claim 9, wherein the time period when an image is not formed on paper comprises a warm-up time period before printing.

16. The apparatus of claim 9, wherein the time period when an image is not formed on paper comprises a cleaning time period after printing.
